(19) United States
(12) Patent Application Publication
(10) Pub. No.: US 2022/0188830 A1
(43) Pub. Date: Jun. 16, 2022

(54) METHOD AND SYSTEM FOR DETECTING FRAUDULENT TRANSACTIONS

(71) Applicant: JPMorgan Chase Bank, N.A., New York, NY (US)

(72) Inventors: Antigoni Ourania POLYCHRONIADOU, New York, NY (US); Prashant P. REDDY, Madison, NJ (US); Manuela VELOSO, New York, NY (US)

(73) Assignee: JPMorgan Chase Bank, N.A., New York, NY (US)

(21) Appl. No.: 17/644,420

(22) Filed: Dec. 15, 2021

Related U.S. Application Data
(60) Provisional application No. 63/129,958, filed on Dec. 23, 2020.

(30) Foreign Application Priority Data
Dec. 16, 2020 (GR) 20200100734

(51) Int. Cl. G06Q 20/40

(52) U.S. Cl. CPC G06Q 20/4016

(57) ABSTRACT

A method and a system for increasing accuracy in fraud detection are provided. The method includes: obtaining a first set of transaction data that relates to a first plurality of transactions, each respective transaction from among the first plurality of transactions having a corresponding originating account and a corresponding beneficiary account; determining, for each corresponding beneficiary account, a number of executed transactions associated with the corresponding beneficiary account by computing a respective PageRank value for a transaction graph associated with the corresponding beneficiary account; and when the respective PageRank value of the beneficiary account exceeds a predetermined threshold, determining that the corresponding beneficiary account is unlikely to be a participant in a future fraudulent transaction. For subsequent transactions, beneficiary accounts that have been determined as being unlikely to participate in future fraudulent transactions may be excluded from applications of fraud detection algorithms, thereby reducing computational load and increasing accuracy.

### CROSS-REFERENCE TO RELATED APPLICATIONS

This application claims priority benefit from Greek Application No. 20200100734, filed Dec. 16, 2020, which is hereby incorporated by reference in its entirety.

This application claims the benefit from U.S. Provisional Application No. 63/129,958, filed Dec. 23, 2020, which is hereby incorporated by reference in its entirety.

### BACKGROUND

### 1. Field of the Disclosure

This technology generally relates to methods and systems for detecting fraudulent transactions, and more particularly to methods and systems for increasing accuracy in fraud detection based on identifying trustworthy beneficiaries of financial transactions.

### 2. Background Information

Financial institutions process a vast amount of transactions per day. Among those, a small fraction are fraudulent transactions. There are several automatic fraud detection systems. Those that rely on historical data and supervised learning suffer from the unbalanced nature of this data, because fraud is a relatively rare event. Several techniques try to mitigate this problem, for instance, by oversampling of fraud events to balance the data. However, because of the relative rarity of fraudulent transactions, conventional fraud detection systems often generate false positives, and the accuracy of these conventional fraud detection systems is reduced.

Accordingly, there is a need for a mechanism to reduce the number of false positives and improve accuracy in fraud detection with respect to financial transactions.

### SUMMARY

The present disclosure, through one or more of its various aspects, embodiments, and/or specific features or sub-components, provides, inter alia, various systems, servers, devices, methods, media, programs, and platforms for increasing accuracy in fraud detection based on identifying trustworthy beneficiaries of financial transactions.

According to an aspect of the present disclosure, a method for increasing accuracy in fraud detection based on identifying trustworthy beneficiaries of financial transactions is provided. The method is implemented by at least one processor. The method includes: obtaining, by the at least one processor, a first set of transaction data that relates to a first plurality of transactions, each respective transaction from among the first plurality of transactions having a corresponding originating account and a corresponding beneficiary account; analyzing, by the at least one processor, information that relates to each corresponding beneficiary account; and determining, by the at least one processor based on a result of the analyzing, whether the corresponding beneficiary account is unlikely to be a participant in a future fraudulent transaction.

The analyzing may include determining, by the at least one processor for each corresponding beneficiary account, a respective number of executed transactions associated with the corresponding beneficiary account. The determining may include determining that the corresponding beneficiary account is unlikely to be a participant in a future fraudulent transaction when the respective number of executed transactions exceeds a predetermined threshold.

The predetermined threshold may be determined based on historical transaction data.

The determining of the respective number of executed transactions may include using, by the at least one processor, a PageRank (PR) algorithm to compute a respective PageRank value for a transaction graph associated with the corresponding beneficiary account. The predetermined threshold may include a predetermined threshold PageRank value.

The predetermined threshold PageRank value may correspond to a relatively high percentage of transactions, such as, for example, at least 45% of a number of transactions included in the first plurality of transactions.

The method may further include: obtaining, by the at least one processor, a second set of transaction data that relates to a second plurality of transactions; generating, by the at least one processor, a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and applying, by the at least one processor, a fraud detection algorithm to the third plurality of transactions.

The analyzing may include determining, by the at least one processor for each corresponding beneficiary account, a respective number of incoming transfers. The determining may include determining that the corresponding beneficiary account is unlikely to be a participant in a future fraudulent transaction when the respective number of incoming transfers exceeds a predetermined threshold.

The determining of the respective number of incoming transfers may include using, by the at least one processor, an in-degree algorithm to compute the respective number of incoming transfers for the corresponding beneficiary account. The predetermined threshold may include a predetermined threshold in-degree value.

According to another aspect of the present disclosure, a computing apparatus for increasing accuracy in fraud detection is provided. The computing apparatus includes a processor; a memory; and a communication interface coupled to each of the processor and the memory. The processor is configured to: obtain a first set of transaction data that relates to a first plurality of transactions, each respective transaction from among the first plurality of transactions having a corresponding originating account and a corresponding beneficiary account; analyze information that relates to each corresponding beneficiary account; and determine, based on a result of the analysis, whether the corresponding beneficiary account is unlikely to be a participant in a future fraudulent transaction.

The processor may be further configured to: determine, for each corresponding beneficiary account, a respective number of executed transactions associated with the corresponding beneficiary account; and determine that the corresponding beneficiary account is unlikely to be a participant in a future fraudulent transaction when the respective number of executed transactions exceeds a predetermined threshold.

The predetermined threshold may be determined based on historical transaction data.

The processor may be further configured to determine the respective number of executed transactions by using a PageRank (PR) algorithm to compute a respective PageRank value for a transaction graph associated with the corresponding beneficiary account. The predetermined threshold may include a predetermined threshold PageRank value.

The predetermined threshold PageRank value may correspond to a relatively high percentage of transactions, such as, for example, at least 45% of a number of transactions included in the first plurality of transactions.

The processor may be further configured to: obtain a second set of transaction data that relates to a second plurality of transactions; generate a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and apply a fraud detection algorithm to the third plurality of transactions.

The processor may be further configured to: determine, for each corresponding beneficiary account, a respective number of incoming transfers; and determine that the corresponding beneficiary account is unlikely to be a participant in a future fraudulent transaction when the respective number of incoming transfers exceeds a predetermined threshold.

The processor may be further configured to determine the respective number of incoming transfers by using an in-degree algorithm to compute the respective number of incoming transfers for the corresponding beneficiary account. The predetermined threshold may include a predetermined threshold in-degree value.

According to yet another aspect of the present disclosure, a non-transitory computer readable storage medium storing instructions for increasing accuracy in fraud detection is provided. The storage medium includes executable code which, when executed by a processor, causes the processor to: obtain a first set of transaction data that relates to a first plurality of transactions, each respective transaction from among the first plurality of transactions having a corresponding originating account and a corresponding beneficiary account; analyze information that relates to each corresponding beneficiary account; and determine, based on a result of the analysis, whether the corresponding beneficiary account is unlikely to be a participant in a future fraudulent transaction.

The executable code may be further configured to cause the processor to: determine, for each corresponding beneficiary account, a respective number of executed transactions associated with the corresponding beneficiary account; and determine that the corresponding beneficiary account is unlikely to be a participant in a future fraudulent transaction when the respective number of executed transactions exceeds a predetermined threshold.

The executable code may be further configured to cause the processor to determine the respective number of executed transactions by using a PageRank algorithm to compute a respective PageRank value for a transaction graph associated with the corresponding beneficiary account. The predetermined threshold may include a predetermined threshold PageRank value.

The executable code may be further configured to cause the processor to: obtain a second set of transaction data that relates to a second plurality of transactions; generate a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and apply a fraud detection algorithm to the third plurality of transactions.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for increasing accuracy in fraud detection based on identifying trustworthy beneficiaries of financial transactions.

FIG. 4 is a flowchart of an exemplary process for implementing a method for increasing accuracy in fraud detection based on identifying trustworthy beneficiaries of financial transactions.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

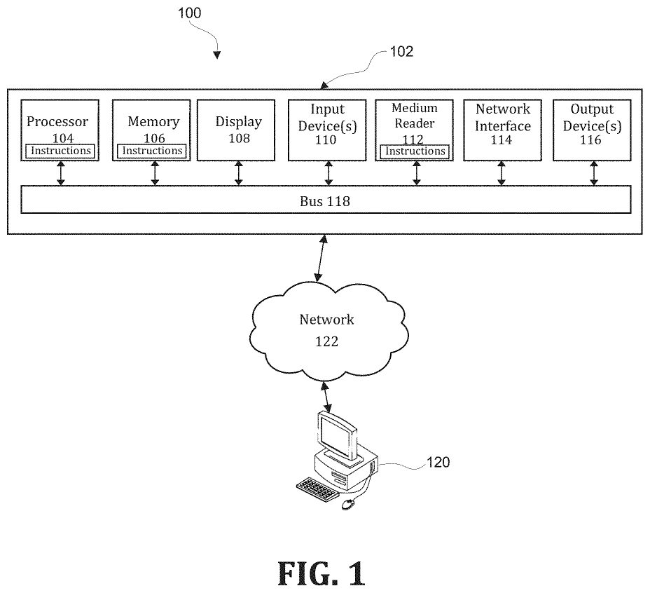

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for increasing accuracy in fraud detection based on identifying trustworthy beneficiaries of financial transactions.

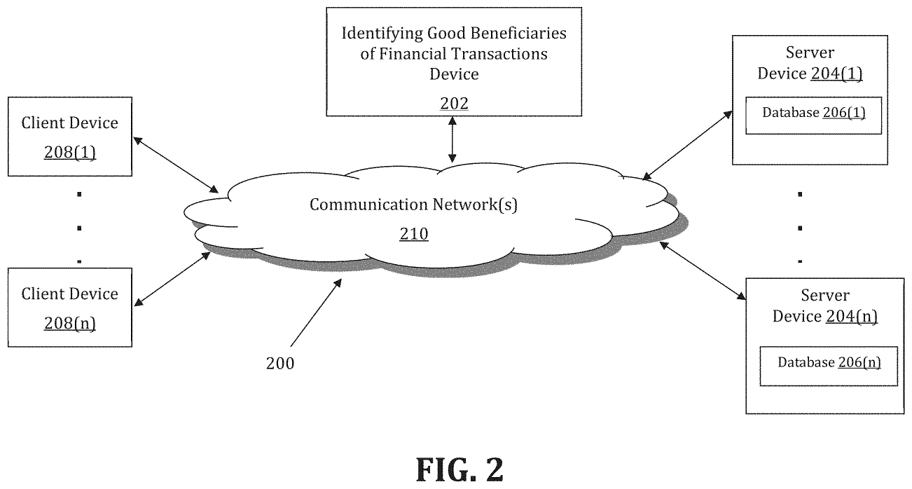

Referring to FIG. 2, a schematic of an exemplary network environment 200 for implementing a method for increasing accuracy in fraud detection based on identifying trustworthy beneficiaries of financial transactions is illustrated. In an exemplary embodiment, the method is executable on any networked computer platform, such as, for example, a personal computer (PC).

The method for increasing accuracy in fraud detection based on identifying trustworthy beneficiaries of financial transactions may be implemented by an Identifying Good Beneficiaries of Financial Transactions (IGBFT) device 202. The IGBFT device 202 may be the same or similar to the computer system 102 as described with respect to FIG. 1. The IGBFT device 202 may store one or more applications that can include executable instructions that, when executed by the IGBFT device 202, cause the IGBFT device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IGBFT device 202 itself, may be located in virtual server(s) running in a cloud-based computing environment rather than being tied to one or more specific physical network computing devices. Also, the application(s) may be running in one or more virtual machines (VMs) executing on the IGBFT device 202. Additionally, in one or more embodiments of this technology, virtual machine(s) running on the IGBFT device 202 may be managed or supervised by a hypervisor.

In the network environment 200 of FIG. 2, the IGBFT device 202 is coupled to a plurality of server devices 204(1)-204(n) that hosts a plurality of databases 206(1)-206(n), and also to a plurality of client devices 208(1)-208(n) via communication network(s) 210. A communication interface of the IGBFT device 202, such as the network interface 114 of the computer system 102 of FIG. 1, operatively couples and communicates between the IGBFT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IGBFT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and IGBFT devices that efficiently implement a method for increasing accuracy in fraud detection based on identifying trustworthy beneficiaries of financial transactions.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The IGBFT device 202 may be a standalone device or integrated with one or more other devices or apparatuses, such as one or more of the server devices 204(1)-204(n), for example. In one particular example, the IGBFT device 202 may include or be hosted by one of the server devices 204(1)-204(n), and other arrangements are also possible. Moreover, one or more of the devices of the IGBFT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the IGBFT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to historical financial transactions and data that relates to individual participants in financial transactions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the IGBFT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the IGBFT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the IGBFT device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IGBFT device 202, the server devices 204(1)-204(n), or the client devices 208(1)-208(n), for example, may be configured to operate as virtual instances on the same physical machine. In other words, one or more of the IGBFT device 202, the server devices 204(1)-204(n), or the client devices 208(1)-208(n) may operate on the same physical device rather than as separate devices communicating through communication network(s) 210. Additionally, there may be more or fewer IGBFT devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

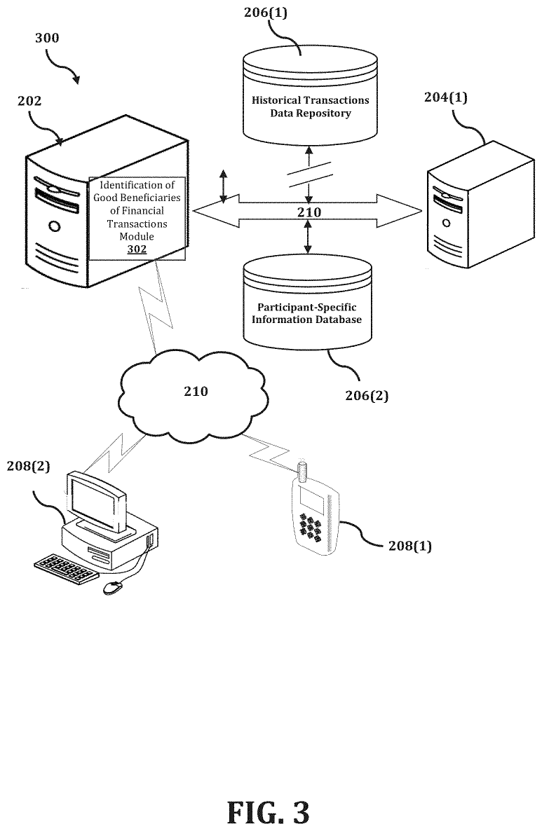

The IGBFT device 202 is described and illustrated in FIG. 3 as including an identification of good beneficiaries of financial transactions module 302, although it may include other rules, policies, modules, databases, or applications, for example. As will be described below, the identification of good beneficiaries of financial transactions module 302 is configured to implement a method for increasing accuracy in fraud detection based on identifying trustworthy beneficiaries of financial transactions.

An exemplary process 300 for implementing a mechanism for increasing accuracy in fraud detection based on identifying trustworthy beneficiaries of financial transactions by utilizing the network environment of FIG. 2 is illustrated as being executed in FIG. 3. Specifically, a first client device 208(1) and a second client device 208(2) are illustrated as being in communication with IGBFT device 202. In this regard, the first client device 208(1) and the second client device 208(2) may be “clients” of the IGBFT device 202 and are described herein as such. Nevertheless, it is to be known and understood that the first client device 208(1) and/or the second client device 208(2) need not necessarily be “clients” of the IGBFT device 202, or any entity described in association therewith herein. Any additional or alternative relationship may exist between either or both of the first client device 208(1) and the second client device 208(2) and the IGBFT device 202, or no relationship may exist.

Further, IGBFT device 202 is illustrated as being able to access a historical financial transactions data repository 206(1) and a participant-specific information database 206(2). The identification of good beneficiaries of financial transactions module 302 may be configured to access these databases for implementing a method for increasing accuracy in fraud detection based on identifying trustworthy beneficiaries of financial transactions.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the IGBFT device 202 via broadband or cellular communication. Of course, these embodiments are merely exemplary and are not limiting or exhaustive.

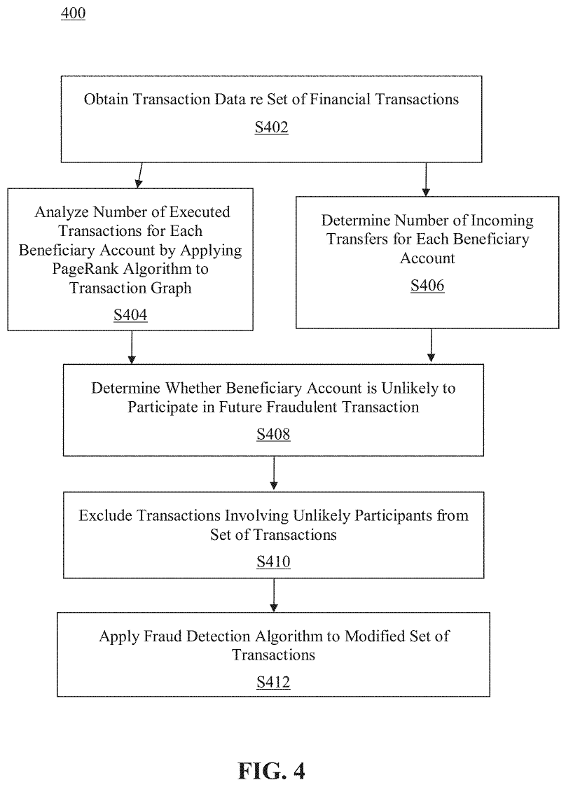

Upon being started, the identification of good beneficiaries of financial transactions module 302 executes a process for increasing accuracy in fraud detection based on identifying trustworthy beneficiaries of financial transactions. An exemplary process for increasing accuracy in fraud detection based on identifying trustworthy beneficiaries of financial transactions is generally indicated at flowchart 400 in FIG. 4.

In process 400 of FIG. 4, at step S402, the identification of good beneficiaries of financial transactions module 302 obtains a first set of transaction data that relates to a first set of financial transactions. For each respective transaction, there is an originating account and a beneficiary account that corresponds to the respective transaction.

After the first set of transaction data has been obtained, the process 400 includes a step that entails analyzing respective information that relates to each corresponding beneficiary account. The analysis of this information may be accomplished in several ways. For example, at step S404, the identification of good beneficiaries of financial transactions module 302 analyzes a number of executed transactions that relates to a respective beneficiary account. In an exemplary embodiment, the analysis of the number of executed transactions may include using a PageRank (PR) algorithm to compute a respective PageRank value for a transaction graph associated with the corresponding beneficiary account.

Alternatively, instead of performing step S404, the identification of good beneficiaries of financial transactions module 302 may perform step S406. At step S406, for each beneficiary account, a determination of a number of incoming transfers is made. In an exemplary embodiment, the number of incoming transfers may be determined by using an in-degree algorithm that effectively computes the number of incoming transfers.

At step S408, the identification of good beneficiaries of financial transactions module 302 uses the result of either step S404 or S406 to determine whether a particular beneficiary account is unlikely to participate in a future fraudulent transaction. In this aspect, the process 400 relies on a conjecture that when a particular beneficiary account is associated with a transaction graph that has a large PageRank value, there is a high probability that the holder of that beneficiary account is not engaged in fraud. Similarly, the process 400 also relies on a conjecture that when a particular beneficiary account is involved in a relatively large number of financial transactions, there is a correspondingly low probability that that same beneficiary account is involved in fraudulent transactions. Thus, at step S408, the identification of good beneficiaries of financial transactions module 302 may set a threshold that corresponds to either the PageRank value of the transaction graph or the number of incoming transfers and then, for each respective beneficiary account, make a determination as to whether or not that beneficiary account can be categorized as being unlikely to participate in a future fraudulent transaction.

At step S410, the identification of good beneficiaries of financial transactions module 302 modifies the first set of transactions by excluding transactions that involve the beneficiary accounts that have been determined as being unlikely to participate in a future fraudulent transaction. In this aspect, the identification of good beneficiaries of financial transactions module 302 reduces the size of the first set of transactions based on the determination that the excluded transactions are not fraudulent.

Then, at step S412, the identification of good beneficiaries of financial transactions module 302 applies a conventional fraud detection algorithm to the modified set of transactions. As a result of the reduced size of the modified set of transactions as compared with the original first set of transactions, the required number of online computation hours is correspondingly reduced.

Analysis of historical data relating to financial transactions has shown that only a small fraction of the vast number of transactions that are processed in any given day are fraudulent. For example, in one historical dataset, the number of transactions was approximately equal to thirty million (i.e., 30,000,000), and of those transactions, approximately seven hundred (i.e., 700) were found to have been fraudulent, and therefore, for that dataset, the probability that any particular transaction was fraudulent was 700/30,000,000=0.00233%. Because this percentage tends to be a very small nonzero number, there is a problem that is often referred to as the “unbalanced” data problem, which leads directly to a greater likelihood of false positives and more errors in fraud detection. In this aspect, as a result of an identification of a significant number of transactions as being associated with trustworthy beneficiaries and therefore unlikely to be involved in a future fraudulent transaction, the unbalanced data problem is mitigated.

In an exemplary embodiment, the PageRank (PR) algorithm may be used to identify trustworthy beneficiaries of money transactions. This method is illustrated by using a sample of real transaction data provided by a financial institution.

Financial institutions process a vast amount of transactions per day. Among those, a small fraction are fraudulent transactions. There are several automatic fraud detection systems. Those that rely on historical data and supervised learning suffer from the unbalanced nature of this data, because fraud is a relatively rare event. Several techniques try to mitigate this problem, for instance, by oversampling of fraud events to balance the data. In an exemplary embodiment, this problem is address via a different approach: given that each transaction has one originating account and one beneficiary account, the methodology entails attempting to identify good beneficiary accounts which are less likely to commit fraud. As a result, the data space of fraud detection systems can be reduced by discarding the data related to good beneficiaries.

In an exemplary embodiment, a historical dataset used herein consists of about thirty million transactions, from which about seven hundred are fraudulent. Each transaction, of a given amount of money, involves an originating account and a beneficiary account.

Graph local properties: The PageRank algorithm is used to identify good beneficiaries. The conjecture is that the accounts (i.e., vertices of the transaction graph) with large PageRank (PR) values already participated in many non-fraudulent transactions; therefore, the probability that the holder of the beneficiary account is a fraudster is negligible.

The PageRank value is a local graph-property of diameter one, since the PageRank value of each node is computed using only the PageRank values of its direct neighbors (noting that the diameter of the local graph-property refers to a distance between neighbors that have an effect on the value in question). Henceforth, the use of another local property is also investigated: the in-degree (ID) property. In this context, the in-degree counts the number of incoming transfers to a given account.

Despite the fact that both PR and ID have the same time-complexity, $\mathcal {O}(|E|+|V|)$, an advantage of ID over PR is that its computation is simpler and non-iterative, therefore faster for big databases. It has been determined that the ID is a good, cheaper approximation of PR, although not as effective for application to the good-beneficiaries identification problem.

PageRank experimental results: First, the PageRank value is computed for every node in the transaction graph. Then, the interval [PRₘᵢₙ, PRₘₐₓ] is discretized in N sub-intervals (also referred to herein as “buckets”).

For each type of transaction, i.e., valid and fraudulent, the fraction of transaction type per bucket is computed, and this yields one distribution for valid transactions, p_{V}, and another distribution for fraudulent transactions, p_{F}.

By using the PR, good beneficiaries may be automatically detected, and thus, in an exemplary embodiment, this henceforth enables an automatic certification of over forty-five percent (>45%) of the total number of transactions.

The implications of these results are threefold. First, fraud detection efforts may be redirected on approximately fifty-five percent (55%) of the data, thus reducing the required number of online computation hours. Second, the unbalanced data problem is mitigated by reducing the negative (i.e., non-fraudulent) cases to almost half of the data, while maintaining all the positive cases (i.e., fraudulent transactions.) Third, data that corresponds to fraudulent transactions with high PR values are automatically detected as being mislabeled data. The second and third implications have the potential to improve the off-line classification results, especially when using supervising classification methods.

The following is a comparison of the results of an existing conventional fraud detection system with the results using the above-described methodology for analyzing real-world transaction data. Therefore, the above-described PR-based algorithm can be used to substantially reduce the number of false positives.

In-degree experimental results: To assess the validity and significance of using the PageRank value, and not a simpler local graph property, the analysis is performed using the in-degree property with respect to the real-world transaction data. In this transaction data set, the in-degree of a node (i.e., account) represents the number of incoming money transfers. Using the in-degree property to automatically validate non-fraudulent beneficiaries would result only in less than twenty-five percent (<25%) of the transactions being automatically validated. Using the in-degree property to reduce the false positives produced by the fraud detection system would result in a reduction of about thirteen percent (˜13%).

PageRank versus In-degree: The proposed PageRank-based method always performs better than using the in-degree property for the problem considered here. In particular, analysis shows that with PageRank, non-fraudulent beneficiaries are automatically validated in about 45% of the transactions and the number of false positives is reduced to about 33%. This confirms that the PageRank value provides non-trivial information about the graph properties of the transactions.

Accordingly, with this technology, an optimized process for increasing accuracy in fraud detection based on identifying trustworthy beneficiaries of financial transactions is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for increasing accuracy in fraud detection, the method being implemented by at least one processor, the method comprising:
obtaining, by the at least one processor, a first set of transaction data that relates to a first plurality of transactions, each respective transaction from among the first plurality of transactions having a corresponding originating account and a corresponding beneficiary account;
analyzing, by the at least one processor, information that relates to each corresponding beneficiary account; and
determining, by the at least one processor based on a result of the analyzing, whether the corresponding beneficiary account is unlikely to be a participant in a future fraudulent transaction.

2. The method of claim 1, wherein the analyzing comprises determining, by the at least one processor for each corresponding beneficiary account, a respective number of executed transactions associated with the corresponding beneficiary account; and
wherein the determining comprises determining that the corresponding beneficiary account is unlikely to be a participant in a future fraudulent transaction when the respective number of executed transactions exceeds a predetermined threshold.

3. The method of claim 2, wherein the predetermined threshold is determined based on historical transaction data.

4. The method of claim 2, wherein the determining of the respective number of executed transactions comprises using, by the at least one processor, a PageRank algorithm to compute a respective PageRank value for a transaction graph associated with the corresponding beneficiary account; and
wherein the predetermined threshold includes a predetermined threshold PageRank value.

5. The method of claim 4, wherein the predetermined threshold PageRank value corresponds to at least 45% of a number of transactions included in the first plurality of transactions.

6. The method of claim 1, further comprising:
obtaining, by the at least one processor, a second set of transaction data that relates to a second plurality of transactions;
generating, by the at least one processor, a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and
applying, by the at least one processor, a fraud detection algorithm to the third plurality of transactions.

7. The method of claim 1, wherein the analyzing comprises determining, by the at least one processor for each corresponding beneficiary account, a respective number of incoming transfers; and
wherein the determining comprises determining that the corresponding beneficiary account is unlikely to be a participant in a future fraudulent transaction when the respective number of incoming transfers exceeds a predetermined threshold.

8. The method of claim 7, wherein the determining of the respective number of incoming transfers comprises using, by the at least one processor, an in-degree algorithm to compute the respective number of incoming transfers for the corresponding beneficiary account; and
wherein the predetermined threshold includes a predetermined threshold in-degree value.

9. A computing apparatus for increasing accuracy in fraud detection, the computing apparatus comprising:
a processor;
a memory; and
a communication interface coupled to each of the processor and the memory, wherein the processor is configured to:
obtain a first set of transaction data that relates to a first plurality of transactions, each respective transaction from among the first plurality of transactions having a corresponding originating account and a corresponding beneficiary account;
analyze information that relates to each corresponding beneficiary account; and
determine, based on a result of the analysis, whether the corresponding beneficiary account is unlikely to be a participant in a future fraudulent transaction.

10. The computing apparatus of claim 9, wherein the processor is further configured to:
determine, for each corresponding beneficiary account, a respective number of executed transactions associated with the corresponding beneficiary account; and
determine that the corresponding beneficiary account is unlikely to be a participant in a future fraudulent transaction when the respective number of executed transactions exceeds a predetermined threshold.

11. The computing apparatus of claim 10, wherein the predetermined threshold is determined based on historical transaction data.

12. The computing apparatus of claim 10, wherein the processor is further configured to determine the respective number of executed transactions by using a PageRank algorithm to compute a respective PageRank value for a transaction graph associated with the corresponding beneficiary account; and
wherein the predetermined threshold includes a predetermined threshold PageRank value.

13. The computing apparatus of claim 12, wherein the predetermined threshold PageRank value corresponds to at least 45% of a number of transactions included in the first plurality of transactions.

14. The computing apparatus of claim 9, wherein the processor is further configured to:
obtain a second set of transaction data that relates to a second plurality of transactions;
generate a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and
apply a fraud detection algorithm to the third plurality of transactions.

15. The computing apparatus of claim 9, wherein the processor is further configured to:
determine, for each corresponding beneficiary account, a respective number of incoming transfers; and
determine that the corresponding beneficiary account is unlikely to be a participant in a future fraudulent transaction when the respective number of incoming transfers exceeds a predetermined threshold.

16. The computing apparatus of claim 15, wherein the processor is further configured to determine the respective number of incoming transfers by using an in-degree algorithm to compute the respective number of incoming transfers for the corresponding beneficiary account; and
wherein the predetermined threshold includes a predetermined threshold in-degree value.

17. A non-transitory computer readable storage medium storing instructions for increasing accuracy in fraud detection, the storage medium comprising executable code which, when executed by a processor, causes the processor to:
obtain a first set of transaction data that relates to a first plurality of transactions, each respective transaction from among the first plurality of transactions having a corresponding originating account and a corresponding beneficiary account;
analyze information that relates to each corresponding beneficiary account; and
determine, based on a result of the analysis, whether the corresponding beneficiary account is unlikely to be a participant in a future fraudulent transaction.

18. The storage medium of claim 17, wherein the executable code is further configured to cause the processor to:
determine, for each corresponding beneficiary account, a respective number of executed transactions associated with the corresponding beneficiary account; and
determine that the corresponding beneficiary account is unlikely to be a participant in a future fraudulent transaction when the respective number of executed transactions exceeds a predetermined threshold.

19. The storage medium of claim 18, wherein the executable code is further configured to cause the processor to determine the respective number of executed transactions by using a PageRank algorithm to compute a respective PageRank value for a transaction graph associated with the corresponding beneficiary account; and
wherein the predetermined threshold includes a predetermined threshold PageRank value.

20. The storage medium of claim 17, wherein the executable code is further configured to cause the processor to:
obtain a second set of transaction data that relates to a second plurality of transactions;
generate a third plurality of transactions by excluding each respective transaction from the second plurality of transactions for which a corresponding beneficiary account is determined as being unlikely to be a participant in a future fraudulent transaction and including each remaining respective transaction from the second plurality of transactions; and
apply a fraud detection algorithm to the third plurality of transactions.
